(19) United States
(12) Patent Application Publication
(10) Pub. No.: US 2004/0104078 A1
(43) Pub. Date: Jun. 3, 2004

(54) Rail and carriage for stairlifts

(76) Inventors: Andreas Csaba Szentistvany, Hampshire (GB); Alan Neil Russel Stannah, West Sussex (GB)

Correspondence Address: Edwin D Schindler, Five Hirsch Avenue, PO Box 966, Coram, NY, 11727-0966, US

(21) Appl. No.: 10/467,874

(22) PCT Filed: Feb. 12, 2002
(86) PCT No.: PCT/GB02/00607

(30) Foreign Application Priority Data
Feb. 12, 2001 (GB) 0103333.1
Oct. 5, 2001 (GB) 0123944.1

(51) Int. Cl. B66B 9/08

(52) U.S. Cl. 187/201; 187/245; 187/406

(57) ABSTRACT

The present invention describes a formed of curved stairlift rail (12) formed by bending two sections (20a), (20b) of a relatively small diameter, standard, round tube to a mating configuration; nestling the tube sections together, one above the other; and then fixing the sections together by, for example, welding along the junctions between the tubes. The invention also describes novel forms of carriage (11) described having fixed central roller assemblies (42, 44); (65), (70), (71); and two outer, leading and trailing, roller assemblies (41, 43); (73a), (73b) which move in a substantially mirror fashion to one another when negotiating inside/outside bends, but which move together, along spaced parallel axes, when the carriage is negotiating transition bends. Spring (50), (90) are provided to bias the outer roller assemblies against the rail.

### FIELD OF THE INVENTION

This invention relates to stairlifts and, in particular, to a curved stairlift.

### BACKGROUND OF THE INVENTION

Many different solutions have been proposed and provided, in the past, for curved stairlifts. A stairlift having a rail formed from two vertically spaced tubes, and having a rack and pinion drive system, has been amongst the most common in the recent past. One example of such a stairlift is described in International Patent Application WO 96/20125, but there are numerous others including some of our own manufacture.

One feature of many twin tube stairlifts is that the spacing between the tubes is varied, the variation providing a mechanical system to ensure that the seat surface, which supports the occupant in use, remains level as the carriage moves along sections of rail arranged at different angles to the horizontal.

More recently, stairlifts have been marketed having a rail formed from a single round-sectioned tube, one such form of lift being described in European Patent 0 853 591. The round sectioned tubular rail of the stairlift described in EP 0 853 591 includes a flange, extending vertically downwards from the outer wall of the tube to provide a surface against which a reaction roller can bear. The combination of flange 20 and reaction roller prevents the stairlift carriage rotating about the tubular rail, the flange being cut or otherwise formed from metal plate and then welded along the outer surface of the tube.

A feature of both the twin tube stairlifts and the single tube stairlifts is that the rails are relatively costly to fabricate. In the case of the twin tube stairlifts, particularly those in which the tube spacing is varied to effect carriage levelling, each tube must be carefully formed, and then the two tubes carefully interconnected to ensure correct spacing. In the case of the single round tube stairlifts, the tube itself is generally of a substantial diameter which not only limits the radius to which it can be bent, but also requires heavy duty equipment to effect bending. Further, the flange must be hand formed in a number of sections from steel plate, placed in a jig with the tube, and then welded to the tube. In our assessment of this type of rail, we have concluded that crafting the flange sections, from plate stock, to fit to curves in the rail, will involve significant skilled manual input as well as significant material wastage.

It is an object of this invention to provide a stairlift and/or stairlift components which go at least some way in addressing the perceived or real drawbacks of existing stairlift configurations, as outlined above, or which will at least provide a novel and useful alternative.

### SUMMARY OF THE IVENTION

Accordingly, in a first aspect, the invention provides a rail for a stairlift essentially comprising, when viewed in cross section, two hollow tubular sections fixed together in close proximity.

Preferably said tubular sections are substantially the same.

Preferably said tubular sections are round tube sections.

Preferably said tubular sections are arranged so that one is on top of the other when said rail is mounted in its operative configuration.

Preferably said rail further includes a drive rack mounted thereon.

In a second aspect the invention provides a method of forming a stairlift rail, said method including the steps of:

forming a first tubular member to conform to the desired rail shape,

forming a second tubular member to conform substantially to the same shape as said first tubular member;

bringing said first and second tubular members into close proximity so as to form a composite of said desired shape; and fixing said first and second tubular members together.

Said first tubular member may not be in direct contact with said second tubular member along the entire length of said rail, if at all. It is envisaged, however, that the proximity will be sufficiently close to enable direct fixing of one to the other, by for example welding, without the need for any intermediate connecting members.

Preferably said first and second members are formed from the same tube stock. Said tube stock is preferably standard section round tube.

Preferably said first and second tubular sections are brought together so that one section is positioned on top of the other when said rail is positioned for use.

In a third aspect, the invention provides a stairlift carriage including at least one first roller positioned to contact a first side of a stairlift rail; and at least two rollers positioned to contact a side of said rail substantially opposite to said first side, relative displacement between said at least one first roller on the one hand, and said at least two rollers on the other hand, being achievable to accommodate the need for variation in roller spacing as said carriage encounters a bend in said rail.

Preferably said at least two rollers are mounted so as to be displaced together with respect to said at least one first roller.

Preferably said at least two rollers comprise three rollers, said three rollers being arranged to contact points spaced along said rail, the axis of the centre roller of said three rollers being fixed with respect to the axis of said at least one first roller, the outer rollers of said three rollers being displaceable with respect to said centre roller.

Preferably the outer two rollers of said three rollers are equidistant from said centre roller, when said carriage is mounted on a horizontal section of rail.

Preferably the axes of said centre roller and said at least one first roller lie in a common vertical plane when said carriage is mounted on a horizontal section of rail.

Preferably said outer rollers are mounted to swivel in a common plane, which common plane is horizontal when said carriage is on a horizontal section of rail.

Preferably each outer roller is constrained to swivel in a direction, and to an extent, which mirrors that of the other outer roller.

Preferably biasing means are provided to bias the axes of said outer rollers toward the surface of said rail. Said biasing means preferably comprise compression springs.

Preferably said carriage further includes at least one reaction roller positioned to, in use, contact said rail, said at least one reaction roller being mounted so as to counter rotation of the carriage about said rail.

Preferably the centre roller of said three rollers is offset from the outer rollers when viewed in a direction looking along said rail, said centre roller being so positioned to, in use, counter torque tending to rotate said carriage about said rail.

In a fourth aspect the invention provides a stairlift including a stairlift rail; and a carriage as set forth in the preceding aspect, mounted for rolling movement along said rail.

Said rail may be of the form set forth in the first aspect hereof or may comprise a single rail component.

Preferably said stairlift further includes a rack mounted on said rail, and a drive pinion mounted on, and driven from within, said carriage.

In a fifth aspect the invention provides a stairlift carriage including a pair of centre rollers rotatable about fixed axes and positioned to contact upper and lower points on a stairlift rail; and at least one outer roller arranged on either side of one of said centre rollers, said outer rollers being capable of movement with respect to said centre rollers, in orthogonal planes, to allow said carriage to, in use, negotiate transition bends and inside/outside bends in said rail.

Preferably a single outer roller is provided on either side of said centre rollers, both outer rollers being positioned to contact upper surface parts of said rail.

Preferably said carriage is further characterised in that, when viewed in elevation on a horizontal section of rail, said outer two rollers are constrained to move together in a vertical plane, and in a mirror fashion to one another in an orthogonal plane.

Preferably said carriage further includes one or more reaction rollers to resist rotation of said carriage about said rail. More preferably one of said reaction rollers is embodied in, or constituted by, the top centre roller.

In a sixth aspect, the invention provides a stairlift including a stairlift rail; and the carriage set forth above, displaceable along said rail.

The rail may be of a form defined in the first aspect hereof, or may comprise a single component member.

In a seventh aspect the invention provides a stairlift carriage having a single roller positioned to contact a first side of a stairlift rail, and three rollers positioned to contact spaced points along a side of said rail substantially opposite to said first side, the axes of said single roller and the centre of said three rollers being fixed in a plane through the contact points of those two rollers and said rail when in use, the outer two of said three rollers being constrained to swivel, in a mirror fashion to one another, in a plane perpendicular to said first mentioned plane, to allow said carriage to, in use, negotiate inside/outside bends in said rail.

Preferably the axis about which each outer roller swivels lies between parallel lines passing through the axes of the respective outer roller, and said centre roller.

Preferably biasing means are provided to bias the axes of said outer rollers toward the surface of said rail. Said biasing means preferably comprise one or more compression springs.

Preferably said carriage further includes at least one reaction roller positioned to, in use, contact said rail, said at least one reaction roller being mounted so as to counter rotation of the carriage about said rail. More preferably one of said reaction rollers comprises the centre roller of said three rollers.

In an eighth aspect the invention provides a stairlift carriage for mounting on a stairlift rail, said carriage having a carriage chassis; a centre roller assembly; a leading roller assembly positioned ahead of said centre roller assembly when viewed in the direction of travel of said carriage; and a trailing roller assembly positioned behind said centre roller assembly when viewed in the direction of travel of said carriage, said centre, leading and trailing roller assemblies being configured and arranged to support said carriage on said rail, and said leading and trailing roller assemblies being constrained to move substantially in a mirror image of one another as said carriage negotiates an inside or an outside bend in said rail; said carriage being characterised in that:

(i) said centre roller assembly is fixed with respect to said carriage chassis; and

(ii) said leading and trailing roller assemblies are mounted to move, together, with respect to said carriage chassis along spaced parallel axes as said carriage negotiates a transition bend in said rail.

Preferably the axes along which said leading and trailing roller assemblies move as said carriage negotiates a transition bend in said rail also define pivot points about which said leading and trailing roller assemblies move as said carriage negotiates an inside/outside bend in said rail.

Preferably said centre roller assembly is configured and arranged to prevent said carriage from rotating about said rail.

Preferably said carriage further includes biasing means to bias said leading and trailing roller assemblies into contact with said rail.

In a ninth aspect the invention provides a stairlift carriage having a plurality of rollers configured and arranged to support said roller on a stairlift rail, said carriage being characterised in that at least one of said rollers is contoured to correspond substantially to the curvature of said rail and is mounted for movement along its axis as said carriage negotiates a bend in said rail.

In a tenth aspect, the invention provides a stairlift assembly including a stairlift rail, and a carriage as set forth in any one of the preceding aspects displaceable along said rail.

Preferably said rail is as set forth in the first aspect hereof.

Many variations in the way the present invention may be performed will present themselves to those skilled in the art. The description which follows is intended as an illustration only and the absence of description of particular alternatives or variants should in no way be applied to limit the scope of the invention. Such description of specific elements which follows should also be interpreted as including equivalents whether existing now or in the future. The scope of the invention should be defined solely by the appended claims.

### BRIEF DESCRIPTION OF THE DRAWINGS

The various aspects of the invention will now be described with reference to the accompanying drawings in which:

FIG. 1: shows a general isometric view of a stairlift assembly incorporating various aspects of the invention;

FIG. 2A: shows isometric views of two rail forming components;

FIG. 2B: shows the components of FIG. 2A combined into a single member;

FIG. 3: shows, in larger scale, a cross section through the member shown in FIG. 2B;

FIG. 4: shows a rear isometric view, in a larger scale, of the stairlift carriage shown in FIG. 1, on a level section of rail;

FIG. 5: shows an end elevation of that which is shown in FIG. 4;

FIG. 6: shows a rear elevation view of that which is shown in FIG. 4;

FIG. 7: shows a plan view of that which is shown in FIG. 4;

FIG. 8: shows a plan view of the positions adopted by the carriage support rollers when negotiating an outside bend;

FIG. 9: shows a similar view to FIG. 8 but with the carriage negotiating an inside bend;

FIG. 10: shows a rear elevation of the relative positions adopted by the carriage support rollers when negotiating a positive transition bend;

FIG. 11: shows a rear elevation of the relative positions of the carriage support rollers when negotiating a negative transition bend;

FIG. 12: shows a rear elevation of a second form of stairlift carriage mounting assembly, for use with the general rail configuration shown in FIGS. 2B and 3, on a level section of rail;

FIG. 13: shows an end view of that which is shown in FIG. 12;

FIG. 14: shows a view along the line X-X in FIG. 12;

FIG. 15: shows a rear elevation of the assembly shown in FIG. 12 but showing the relative positions of the carriage support rollers when the carriage is negotiating a positive transition bend;

FIG. 16: shows a view similar to FIG. 15 but with the carriage negotiating a negative transition bend;

FIG. 17: shows a plan view of that which is shown in FIG. 12 illustrating the relative positions of the carriage support rollers whilst the carriage is negotiating an inside bend in a horizontal plane;

FIG. 18: shows a view similar to FIG. 17 but with the carriage negotiating an outside bend;

FIG. 19: shows a rear elevation of a third form of stairlift carriage mounting assembly, for use with the general rail configuration shown in FIGS. 2B and 3, on a level section of rail;

FIG. 20: shows a rear elevation of the assembly shown in FIG. 19 but showing the relative positions of the carriage support rollers when the carriage is negotiating a positive transition bend;

FIG. 21: shows a view similar to FIG. 20 but with the carriage negotiating a negative transition bend; and

FIG. 22: shows a plan view of that which is shown in FIG. 19 illustrating the relative positions of the carriage support rollers whilst the carriage is negotiating an inside bend in a horizontal plane.

Detailed View of Working Embodiment

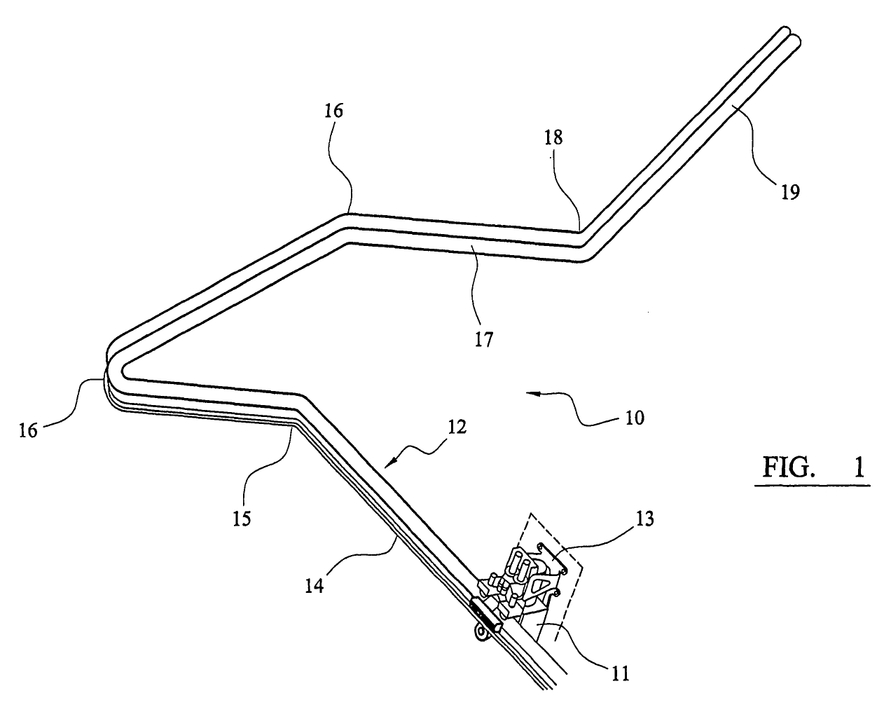

Referring firstly to FIG. 1, a stairlift assembly 10 is depicted including a carriage 11 mounted on a rail 12. In the conventional manner, the carriage provides for a chair (not shown) to be mounted on interface 13, the interface enabling the orientation of the chair with respect to the carriage 11, to be varied.

In the form shown in FIG. 1, the rail 12 comprises a composite tubular member whose precise form and construction will be described in greater detail below. The rail 12 is shown in a form in which such a rail might typically be found in a staircase. To this end, in the form shown, the rail assembly has a first upwardly extending section 14 leading into a positive transition bend 15. The bend 15, in turn, leads to a horizontal section traversing a landing area. Two outside bends 16 change the direction of the rail in a horizontal plane and the short horizontal section 17, following the second of the outside bends 16, terminates in a negative transition bend 18 which leads in to a further, upwardly extending, section 19.

It will be appreciated that, as is standard practice in the stairlift industry, inside/outside are the terms used to describe bends in a substantially horizontal plane whilst transition bends are those in a vertical plane.

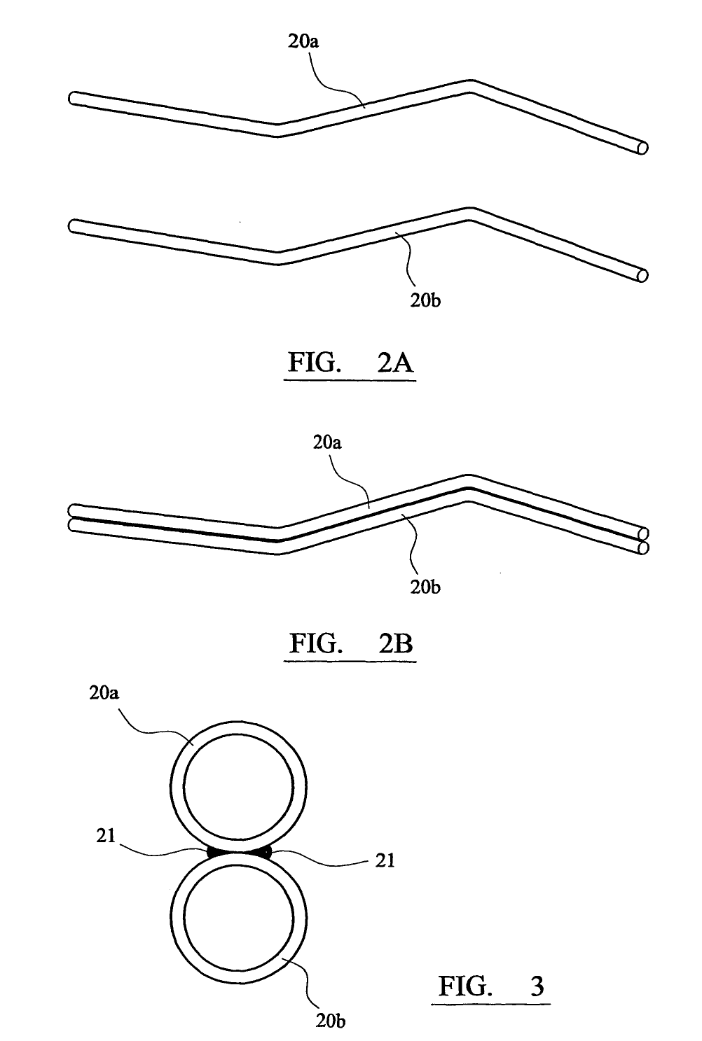

Referring now to FIGS. 2A, 2B and 3, according to one aspect of the invention, the rail 12 is formed from two like tubular components 20a and 20b. In the form shown each component 20a, 20b is formed separately, but to substantially the same shape, from identical standard section round tube. It will be appreciated that the components 20a and 20b are not identical as the radii of one need to be varied a little to allow the two components to nest together accurately.

After formation of the individual components, the two are nested together as shown in FIG. 2B, and then fixed by, for example, welding. As can be seen most clearly from FIG. 3, the component 20a is placed on top of component 20b and the two then fixed together by welding 21 on either side of the junction between the components 20a, 20b. In practice, however, sufficient strength may be achieved by stitch welding on one side only, in which case it is preferred to weld on that side of the rail which, in use, faces rearward since this arrangement presents a visible face which is free of joints, and is thus more aesthetically pleasing.

It will also be appreciated that the two components 20a and 20b may not be in complete contact along the entire length of the rail 12. The present invention envisages that the two will be sufficient close for one to brace the other with only the fixing welds connecting the two, and not any separate interconnecting members.

We have found that satisfactory performance can be achieved using round mild steel tubing of 45.45 mm o/d and having a wall thickness of 4 mm. The advantage of using tube of this form is that it is readily available, relatively inexpensive and easy to form and fix. It will be appreciated, however, that one or both of the tubes 20a, 20b may be of a different form and specification without departing from the scope of this invention.

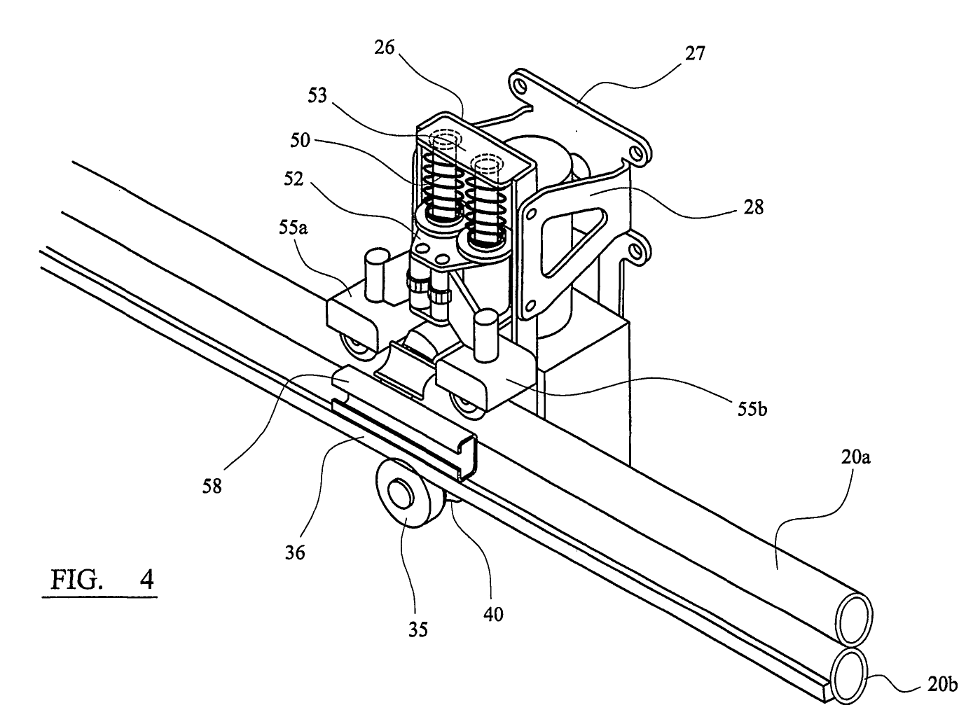

Referring now to FIGS. 4 to 11, the carriage 11 includes an upright chassis 25 having a unshaped rear member 26 and a planar front surface 27, the rear and front members 26 and 27 being held in spaced relationship by side bracket members 28. Located within the chassis interior 30, defined by members 26, 27 and 28, are a drive motor 31 and right angle gearbox 32.

The output of the gearbox is defined by shaft 33 on which is mounted drive pinion 35, the drive pinion being arranged to engage downward facing gear rack 36 fixed to, and extending along, component 20b of rail 12. It will be appreciated, however, that the roller arrangement described herein could also be applied to stairlifts incorporating other forms of drive arrangement, including friction drive.

It will be seen that the rack 36 is offset from a vertical axis through the centre of the rail 12 and does not project below the lowest extremity of the rail 12. This allows the rail to be mounted closer to the staircase nosing and, in turn, allows greater design latitude in ensuring the carriage footrest (not shown) is positioned closer to the floor surfaces at either end of the rail. The rack is preferably mounted on that side of the rail which, in use, faces rearward and is therefore adjacent the wall of the stairway against which the assembly is mounted. This largely masks the rack from sight and, in turn, reduces the visual impact of the installation. Further, mounting the rack in this position reduces the chance of contact between a user of the installation, and the grease bearing surface of the rack.

The carriage 11 is mounted the rail 12 by a roller set, the roller set not only providing for stability of the carriage on the rail, but also allowing the carriage to roll along the rail safely and efficiently negotiating inside/outside bends, transition bends, and combinations of such bends.

In the form shown in FIGS. 4 to 7, the roller set comprises a first, single, roller 40 engaging the periphery of the rail 12 at a first location; and rollers 41, 42 and 43 which engage spaced points on the periphery of the rail substantially opposite to the point of contact of the first roller 40, although it will be appreciated from the drawings that the centre roller 42 is offset out of line from rollers 41 and 43 to help counter torque tending to rotate or twist the carriage about the rail. Such torque would arise, for example, from a user occupying a chair (not shown) attached to the carriage.

In this preferred embodiment, the rollers 41, 42 and 43 engage upper parts of the rail 12 while the roller 40 engages the bottom of the rail.

The broad principle of operation of the carriage herein described is that the centre rollers rotate about fixed axes whilst all the roller displacement necessary to accommodate inside/outside bends, and transition bends, is provided by outer rollers.

The outer rollers are symmetrical about the centre line to provide correct geometry on all types of bends, and their movements are linked together to ensure carriage stability. More particularly, the axes of rollers 40 and 42 are fixed with respect to each other and with respect to rear chassis member 28. However, as will be described in greater detail below, the outer top rollers 41 and 43 are displaceable, both vertically in a plane parallel to the plane of member 28, and towards and away from the member 28.

Biasing means are provided to bias the axes of the rollers 41 and 43 against the rail 12 and, in so doing, draw the axis of roller 40 against the opposite side of the rail 12. In the form shown the biasing means comprises a pair of compression coil springs 50 surrounding pillars 51, which pillars 51 are mounted on, and fixed with respect to, the rear member 26. Slidably mounted on the pillars 51 is a bearing block 52, the compression springs 50 acting between the bearing block 52 and upper keeper plate 53 mounted across the upper ends of the pillars 51. It will be appreciated, however, that the biasing means could take forms other than the compression coil springs depicted in the drawings. For example, the compression coil springs could be replaced by gas springs or by a mechanical lever system of the type described in our pending International Patent Application No. PCT/GB01/02941.

As can be seen, the single bottom roller 40 is mounted on gearbox output shaft 33 though, unlike the drive pinion 35 which is fixed on the shaft 33 to rotate therewith, the roller 40 is freely rotatable on the shaft 33.

As described above, the axes of the centre upper roller 42 is fixed with respect to the axis of the roller 40. To this end, the roller 42 is mounted on a stub shaft 45 projecting obliquely from the outer end of bracket 46 fixed to, and extending rearward from, the rear member 26.

In order to provide the required movement in orthogonal planes, the rollers 41 and 43 are mounted for rotation about their respective axes in swivel brackets 55a and 55b, the brackets 55a, 55b being pivotally mounted on bearing block 52 via pivot pins 57.

Since the bearing block 52 is slidable, in its entirety, up and down the pillars 51, this means that the rollers 41 and 43 can both translate and swivel with respect to the rear member 26, and thus with respect to centre rollers 40 and 42.

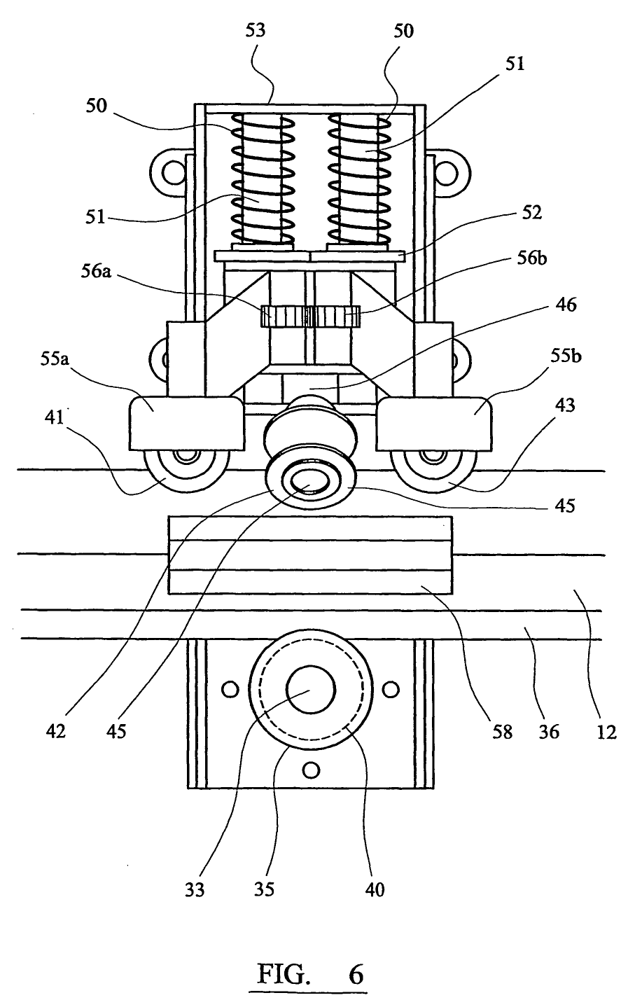

It will be noted that when the carriage is viewed as in FIGS. 6 and 7, that the axes of pins 57 lie between a vertical plane passing through the axis of rollers 40 and 42, and respective parallel vertical planes passing through the axes of rollers 41 and 43.

It will be appreciated that the swivel action of brackets 55a, 55b about the swivel pins 57 enables the rollers 41 and 43 to re-align themselves as the carriage encounters inside and outside bends, in a manner which will be described and illustrated below.

The sliding movement of the bearing block 52 along the pillars 51 allows the carriage to accommodate transition bends in a manner which will also be described and illustrated in following parts of this description.

Given that the axes of the centre line rollers 40 and 42 are fixed with respect to the rail, and that the outer top rollers 41 and 43 can swivel, there is a need to introduce some form of stability control. As far as vertical stability is concerned, this is achieved by both brackets 55a, 55b both being mounted on bearing block 52 which ensures that the two move simultaneously in a plane parallel to the rear member 26. However, as far as stability in an orthogonal plane is concerned, this is achieved by providing the brackets with intermeshing gear sections 56a and 56b as can be seen in FIG. 6. These gear sections 56a, 56b ensure the brackets always swivel to the same extent, but in an opposite sense. In other words that the swivel movement of one is mirrored by the other.

As described above, apart from providing rollers to accommodate the various types of bend in a curved stairlift rail, there is also a need to prevent the carriage from twisting or rotating about the rail when the installation is in use. A degree of resistance to this type of twisting or rotation is provides by the edges of the rollers 40, 41, 42 and 43. However, if these edges were relied on alone, stability and wear problems would inevitably arise. With this in mind one or more reaction rollers are provided.

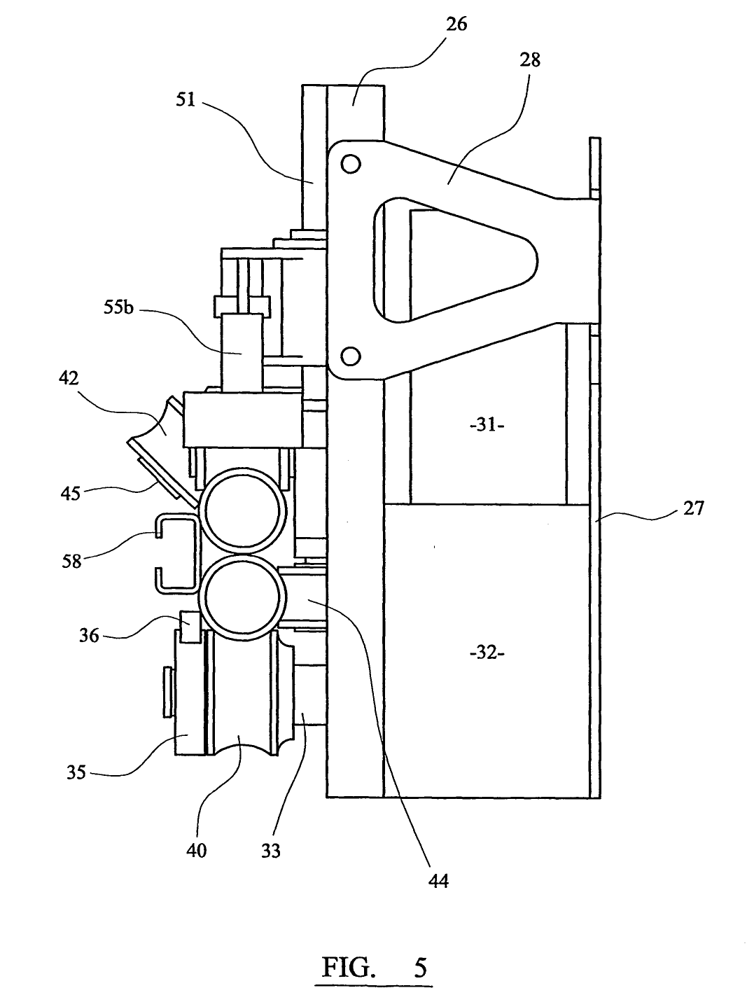

As can be best seen in FIG. 5, a first reaction roller 44 is mounted to rotate about an axis parallel to the rear member 26 and is positioned between the rear member 26 and the rail to resist rotation of the carriage about the rail as would be induced by a passenger mounting the stairlift. The roller 44 is also mounted to “float” to a limited extent along its axis and thereby accommodate manufacturing tolerances inherent in the rail 12. Reaction against the upper part of the rail is preferably achieved, as shown, by offsetting the top centre roller 42. By mounting the roller 42 in this manner, the operating geometry requirements are achieved, the anti-rotation requirement is achieved, and the roller 42 is able to clear channel members 58 fixed to the rail 12, at various points along the rail, to facilitate mounting of the assembly 10 in a staircase.

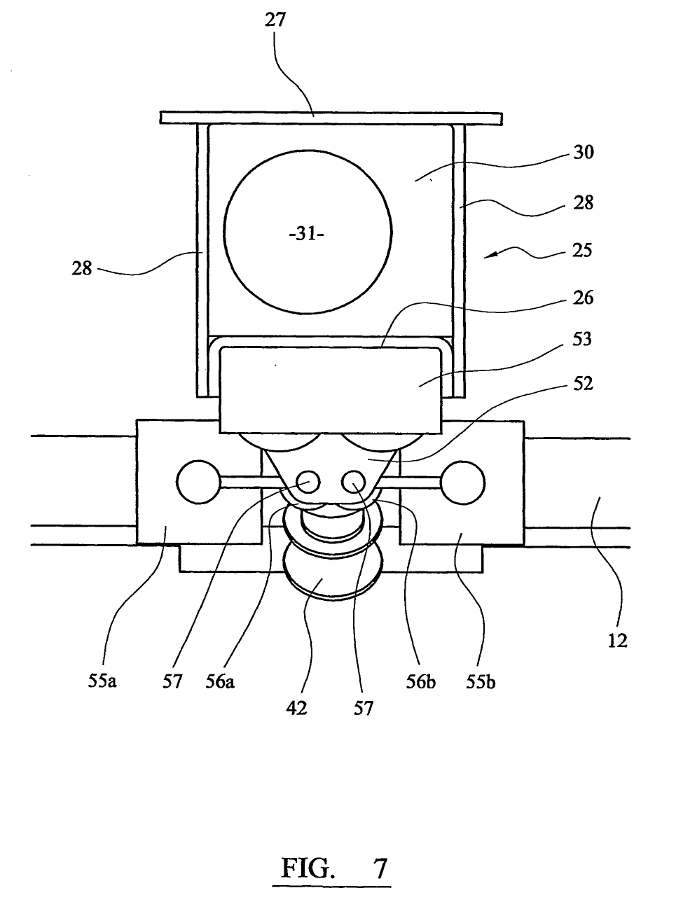

Turning now to FIGS. 8 and 9, when the carriage encounters an inside or an outside bend (in a horizontal plane), the rollers 41 and 43 in respective swivel brackets 55a, 55b swivel about pins 57 so as to adapt to the curve of the rail. Because of the presence of gear sections 56a and 56b, as the leading roller 41 or 43 encounters the bend, the degree of swivel it is constrained to adopt is translated into an equal and opposite degree of swivel on the trailing roller. This, in turn, means that the carriage is prevented from tilting as bends are negotiated, and stability is maintained at all times.

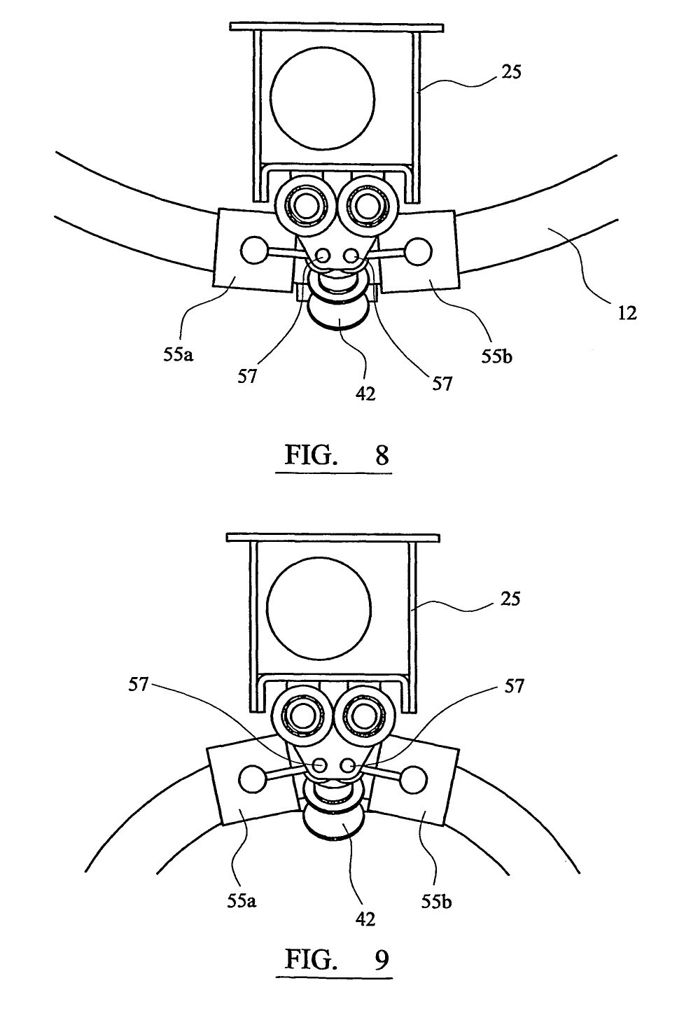

The respective positions of the rollers when encountering bends in a vertical plane (transition bends) is shown in FIGS. 10 and 11.

When the carriage encounters a positive transition bend, as shown in FIG. 10, the spacing between the roller 40 on the one hand, and the rollers 41 and 43 on the other hand, needs to be less than that when the carriage is travelling on a straight section of rail as shown in FIG. 6. Thus, the springs 50 expand, displacing the bearing block 52 and swivel brackets 55a, 55b down over pillars 51 to reduce the spacing as can be seen in the drawing.

In FIG. 11, the carriage is shown negotiating a negative transition bend. In this situation the bend geometry causes the spacing between the axis of roller 40 on the one hand, and the axes of rollers 41 and 43 on the other hand, to be displaced further apart than they would be if the carriage was negotiating a straight section of rail as shown in FIG. 6. This displacement occurs against the bias of compression springs 50 and causes the springs 50 to compress further as can be seen in the drawings.

In the preceding description, the novel support roller configuration has been shown applied to the double tube rail arrangement shown most clearly in FIG. 3. It will be appreciated, however, that the same novel support roller arrangement could also be used in conjunction with other rail forms including a single rail component having an elongated cross-section. Conversely, the twin tube rail configuration described with reference to FIGS. 2A, 2B and 3 could also be used as the basis of a straight line stairlift in conjunction with a carriage considerably more simple in form than that described herein.

The carriage as above described may be used with any suitable chair and chair interface, one of these components including suitable levelling means to ensure the chair seat surface is maintained level irrespective of the position of the carriage on the rail 12.

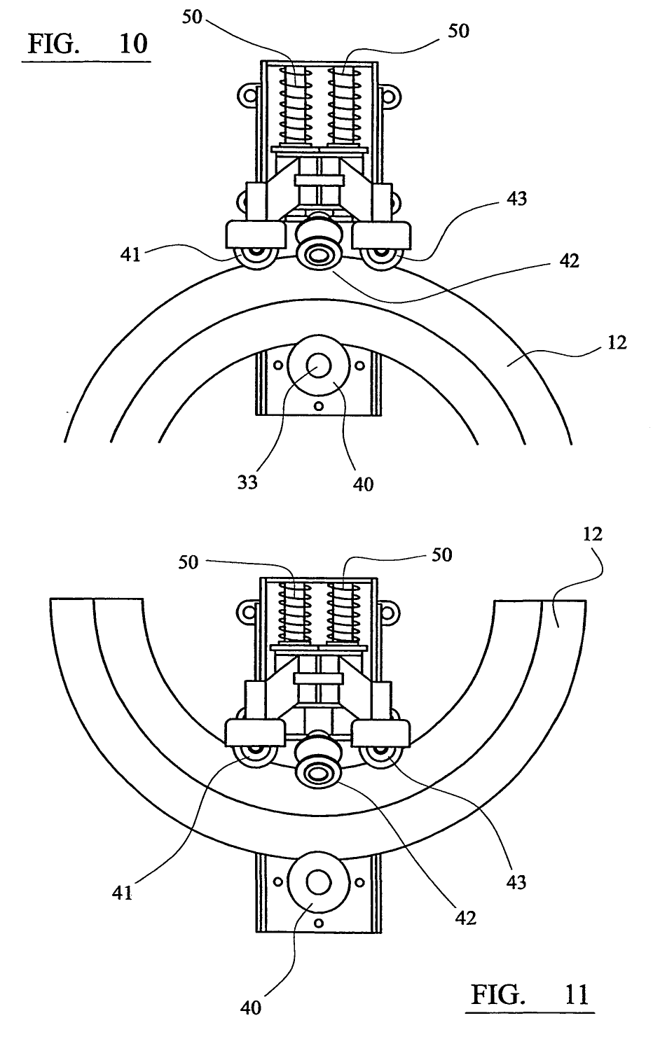

Turning now to FIGS. 12 to 18, a further form of carriage roller arrangement is shown for mounting carriage 11 on the rail 12. In a similar manner to the carriage described above, the form of carriage shown in FIGS. 12 to 18 includes an upright chassis 60 having a rear surface 61. The chassis 60 houses a motor 62 and gearbox 63.

The output of gearbox 63 is defined by an output shaft 64 on which is mounted bottom support roller 65 and drive pinion 66. The drive pinion 66 is positioned to engage downward facing drive rack 68 (FIG. 13) extending along the lower rear edge of component 20b of the rail 12. The arrangement and positioning of the rack 66 is the same as that described above in relation to FIGS. 4 to 11.

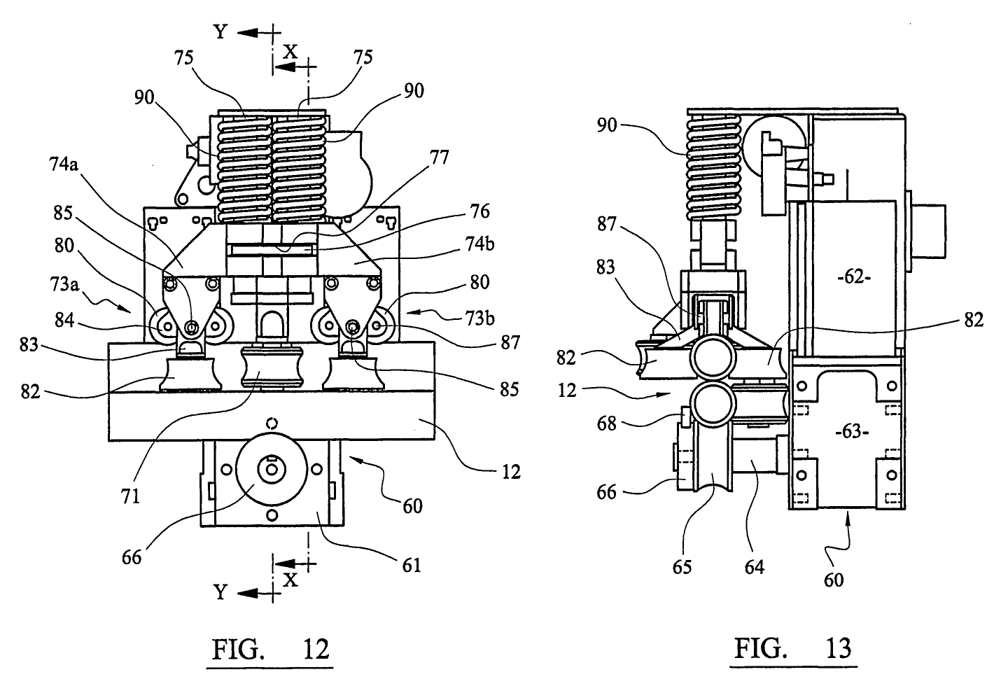

As with the arrangement described above, the carriage is supported on the rail by a combination of rollers or roller sets whose axes are fixed (“the fixed rollers”) and those whose axes may move (“the moveable rollers”). The fixed rollers are positioned substantially on the centreline Y-Y of the chassis when viewed in the direction of travel of the carriage i.e. as depicted in FIG. 12. The fixed rollers are illustrated clearly in FIG. 14 and comprise a centre roller assembly in the form of bottom support roller 65 positioned to contact the undersurface of the rail; inner roller 70 positioned to contact the front surface of component 20b of the rail 12; and outer roller 71 positioned to contact the rear surface of component 20a of the rail 12. It will be appreciated that the prime function of the rollers 70 and 71 is to resist torque loads tending to rotate the carriage about the rail.

The moveable rollers are preferably arranged symmetrically about axis Y-Y when viewed as in FIG. 12, one set comprising a leading roller assembly whilst the other set comprises a trailing roller assembly. Which is which depends on the direction of travel of the carriage.

In the form shown, the moveable rollers comprise roller sets 73a, 73b mounted on moveable brackets 74a, 74b respectively. In the same manner as described above in relation to brackets 55a, 55b, the brackets are mounted so as to translate, together, up and down on spaced parallel pillars 75. Also, the brackets 74a, 74b are constrained to rotate about pillars 75 in a mirror image to one another. To this end the inner facing surfaces of brackets 74a and 74b may be formed with co-operating geared surfaces 78. To ensure that the brackets 74a, 74b move together up and down pillars 75, a small link plate 76 is provided which is retained in aligned, horizontal slots 77 in the brackets 74a, 74b.

Although not illustrated clearly in the drawings, the axis of each pillar 75 is preferably positioned mid-way between axis Y-Y and the axes of rollers 82 on the respective side of axis Y-Y, when viewed as in FIG. 12.

Each of the roller sets 73a, 73b comprises four rollers, two top rollers 80 and two side rollers 82. The side rollers 82 are mounted in inverted v-shaped brackets 83 (FIG. 13), the brackets 83 having extensions 84 to mount the top rollers 80. The brackets 83 pivot about axes 85 in the brackets 74a, 74b. Further, in accordance with another aspect of the invention, each top roller 80 may move axially along the pivot pin 87 on which it is supported within bracket extension 84 as the carriage negotiates an inside or outside bend as will be described below.

It will be noted that, when the carriage is in the configuration shown in FIG. 12, the axes of rollers 80 are equi-spaced from a vertical line through the respective axis 85.

As can be seen, the side rollers 82 are configured and positioned to contact opposite points on the upper half of the rail 12, i.e. opposite sides of rail component 20a.

The “wrap around” effect of rollers 80 and 82, particularly evident when viewed in FIG. 13, reduces point loads on the rail when compared with the arrangement illustrated in FIGS. 4 to 11 and reduces the tendency of the carriage to lift off the rail in transition bends. An associated benefit is that springs 90 can be a less strength than springs 50 described above.

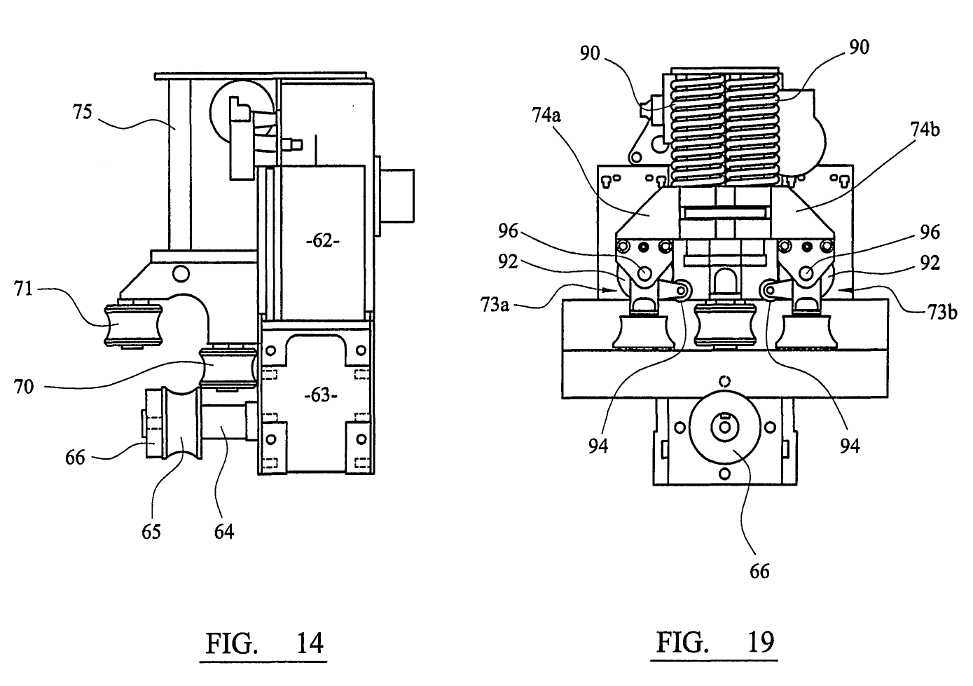

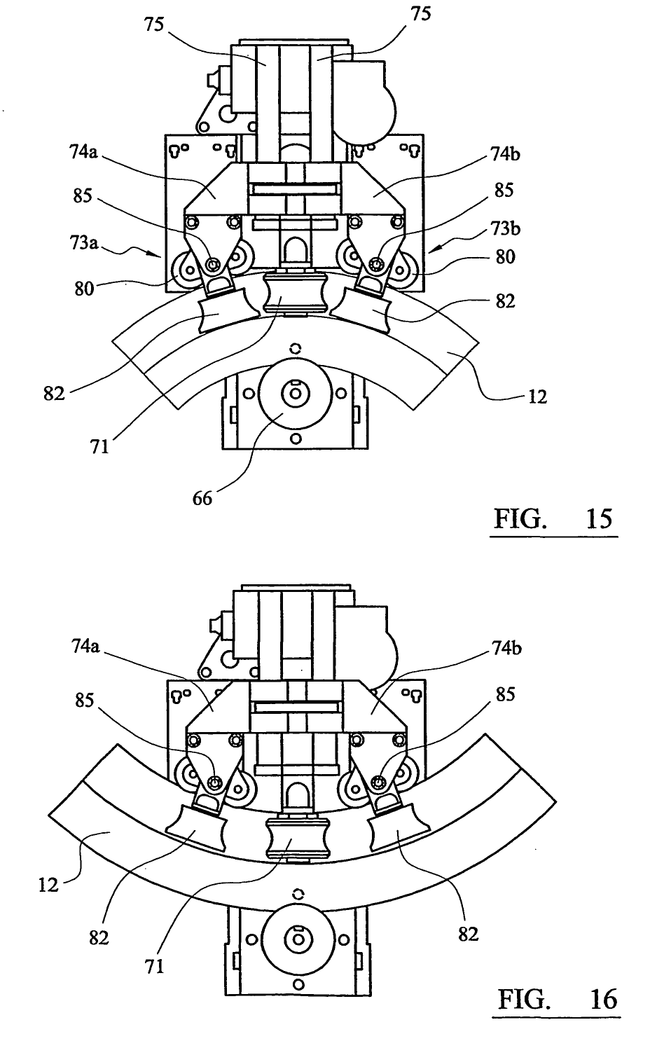

Turning specifically to FIGS. 15 and 16, when the carriage encounters a positive or negative transition bend, the roller sets 73a, 73b pivot, in brackets 83, about pivot axes 85. In a positive transition bend such as is shown in FIG. 15, the brackets 74a, 74b will also be displaced down pillars 75 under the influence of compression springs 90, the springs 90 being illustrated in FIGS. 12 and 13, but not in FIGS. 15 to 18. In a negative transition bend, such as is shown in FIG. 16, the brackets will be displaced up pillars 75, by the curvature of the rail 12, against the bias of springs 90.

The pivotal positions of rollers sets 73a and 73b about their respective pivot axes 85 is determined solely by the rail configuration. Thus, in the middle of a transition bend, as is shown in both of FIGS. 15 and 16, the roller sets 73a and 73b will generally be mirror images of one another about the centreline of the carriage. However, when the carriage is entering or leaving a transition bend, the leading roller set in the direction of travel will not be positioned in a mirror image of the trailing roller set.

Turning now to FIGS. 17 and 18, when the carriage encounters a bend in a horizontal place—an inside or outside bend, the leading roller set 73a, 73b, is constrained to adopt the curvature of the bend. By virtue of geared surfaces 78, movement of the leading roller set is transferred to the trailing roller set in an opposite sense; in other words, the brackets 74a, 74b are displaced in a mirror image of one another as shown. However entry into, and exit from, an inside or outside bend will also cause the leading top roller 80 to move axially along its respective pivot pin 87. In these situations therefore, the roller sets 73a and 73b will not be exact mirror images of one another, though it will be appreciated that the leading and trailing roller assemblies are always substantial mirror images of one another.

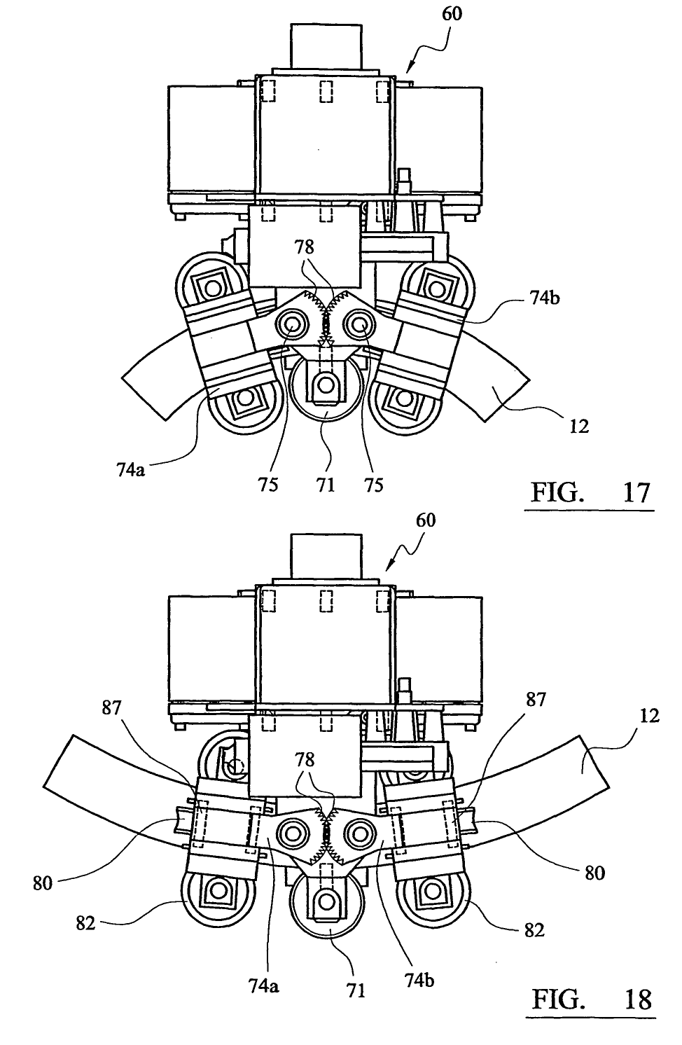

Turning now to FIGS. 19 to 21, these show a third form of carriage mounting assembly which is nearly identical to that just described with reference to FIGS. 12 to 18. The principal difference is that the two top rollers 80 of each outer roller set 73a, 73b have been replaced by a single upper support roller 92 acting in conjunction with a torque resisting device, in this case sub-roller 94. Each sub-roller 94 is mounted in a differently configured extension 95 forming part of the roller set bracket 83 described above.

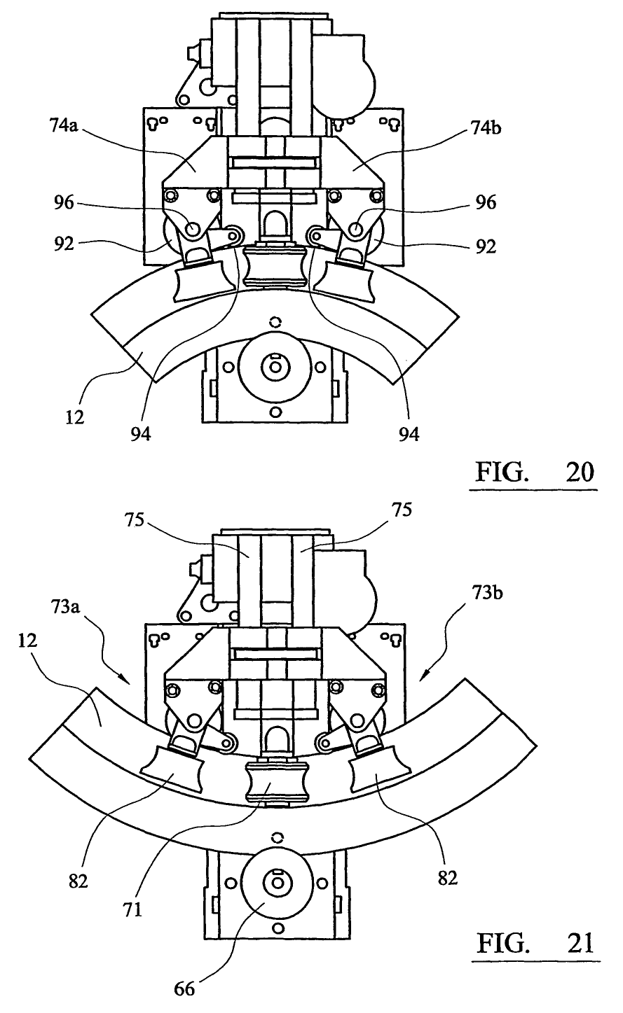

The sub-roller 94 is biased into contact with the upper surface of rail 12 by means of any suitable form of biasing means (not shown). One convenient form of biasing means comprises torsion springs mounted about axes 96 about which rollers sets 73a, 73b pivot when negotiating transition bends as shown in FIGS. 20 and 21.

It will be appreciated that, as the carriage enters, traverses or leaves a transition bend, the effect of sub-rollers 94 acting about pivots 96 (but being held against the rail by the biasing means) correctly aligns side rollers 82 with the rail curvature.

All three arrangements are broadly the same in that they combine an inner fixed roller set with outer moveable rollers. As stated above, the second and third arrangements illustrated in FIGS. 12 to 21 spread the outer loads between a number of rollers thus reducing individual roller loads and point loads on the rail. Further, torque loadings are reduced which, in turn, reduces the biasing required from springs 90.

It will thus be appreciated that the present invention provides a relatively simple yet novel form of support roller arrangement for a stairlift which, particularly in the case of the working embodiments described herein is believed to have the following overall advantages:

1) The rail formed from standard section round tube is relatively simple and inexpensive to manufacture;

2) The rack is positioned to the rear of the rail and is downward facing which provides aesthetic benefits as well as minimising the possibility of users coming into contact with a greasy component; and

3) The stairlift components are all extremely compact in size which reduces the aesthetic impact of the stairlift installation.

1) a rail for a stairlift essentially comprising, when viewed in cross section, two hollow tubular sections fixed together in close proximity.

2) A rail as claimed in claimed in claim 1 where said tubular sections are substantially the same.

3) A rail as claimed in claim 1 or claim 2 wherein said tubular sections are round tube sections.

4) A rail as claimed in any one of claims 1 to 3 wherein said tubular sections are arranged so that one is on top of the other when said rail is mounted in its operative configuration.

5) A rail as claimed in any one of the preceding claims further including a drive rack mounted thereon.

6) A rail for a stairlift when constructed arranged and operable substantially as herein described with reference to, and as illustrated in, FIGS. 2A, 2B and 3 of the accompanying drawings.

7) A method of forming a stairlift rail, said method including the steps of:
forming a first tubular member to conform to the desired rail shape,
forming a second tubular member to conform substantially to the same shape as said first tubular member;
bringing said first and second tubular members into close proximity so as to form a composite of said desired shape; and
fixing said first and second tubular members together.

8) A method as claimed in claim 7 wherein said first and second tubular members are brought into sufficiently close proximity to enable direct fixing of one to the other without the need for any intermediate connecting members.

9) A method as claimed in claim 7 or claim 8 wherein said tubular members are fixed together by welding.

10) A method as claimed in any one of claims 7 to 9 wherein said first and second tubular members are formed from the same tube stock.

11) A method as claimed in claim 10 wherein said tube stock is standard section round tube.

12) A method as claimed in any one of claims 7 to 11 wherein said first and second tubular sections are brought together so that one section is positioned on top of the other when said rail is positioned for use.

13) A method of forming a stairlift rail substantially as herein described with reference to FIGS. 2A, 2B and 3 of the accompanying drawings.

14) A stairlift carriage having at least one first roller positioned to contact a first side of a stairlift rail; and at least two rollers positioned to contact a side of said rail substantially opposite to said first side, relative displacement between said at least one first roller on the one hand, and said at least two rollers on the other hand, being achievable to accommodate the need for variation in roller spacing as said carriage encounters a bend in said rail.

15) A stairlift carriage as claimed in claim 14 wherein said at least two rollers are mounted so as to be displaced together with respect to said at least one first roller.

16) A stairlift carriage as claimed in claim 14 or claim 15 wherein said at least two rollers comprise three rollers, said three rollers being arranged to contact points spaced along said rail, the axis of the centre roller of said three rollers being fixed with respect to the axis of said at least one first roller, the outer rollers of said three rollers being displaceable with respect to said centre roller.

17) A stairlift rail as claimed in claim 16 wherein, the outer two rollers of said three rollers are equidistant from said centre roller.

18) A stairlift carriage as claimed in claim 16 or claim 17 wherein the axes of said centre roller and said at least one first roller lie in a common vertical plane when said carriage is mounted on a horizontal section of rail.

19) A stairlift carriage as claimed in any one of claims 16 to 18 wherein said outer rollers are mounted to swivel in a common plane, which common plane is horizontal when said carriage is on a horizontal section of rail.

20) A stairlift carriage as claimed in any one of claims 16 to 19 wherein each outer roller is constrained to swivel in a direction, and to an extent, which mirrors that of the other outer roller.

21) A stairlift carriage as claimed in any one of claims 16 to 20 further including biasing means to bias the axes of said outer rollers toward the surface of said rail.

22) A stairlift carriage as claimed in claim 21 wherein said biasing means comprise compression springs.

23) A stairlift carriage as claimed in any one of claims 16 to 22 further including at least one reaction roller positioned to, in use, contact said rail, said at least one reaction roller being mounted so as to counter rotation of the carriage about said rail.

24) A stairlift carriage as claimed in claim 23 wherein the centre roller of said three rollers is offset from the outer rollers when viewed in a direction looking along said rail, said centre roller being so positioned to, in use, act as said reaction roller.

25) A stairlift including a stairlift rail; and a carriage as set forth in any one of claims 14 to 24 mounted for rolling movement along said rail.

26) A stairlift as claimed in claim 25 incorporating the rail claimed in any one of claims 1 to 6.

27) A stairlift carriage as claimed in claim 25 or claim 26 further including a rack mounted on said rail, and a drive pinion mounted on, and driven from within, said carriage, said pinion being engaged with said rack to drive said carriage along said rail.

28) A stairlift carriage including a pair of centre rollers rotatable about fixed axes and positioned to contact upper and lower points on a stairlift rail; and at least one outer roller arranged on either side of one of said centre rollers, said outer rollers being capable of movement with respect to said centre rollers, in orthogonal planes, to allow said carriage to negotiate transition bends and inside/outside bends in said rail.

29) A stairlift carriage as claimed in claim 28 wherein a single outer roller is provided on either side of said centre rollers, both outer rollers being positioned to contact upper surface parts of said rail.

30) A stairlift carriage as claimed in claim 29 wherein said carriage is further characterised in that, when viewed in elevation on a horizontal section of rail, said outer two rollers are constrained to move together in a vertical plane, and in a mirror fashion to one another in an orthogonal plane.

31) A stairlift carriage as claimed in any one of claims 28 to 30 further including one or more reaction rollers to resist rotation of said carriage about said rail.

32) A stairlift carriage as claimed in claim 31 wherein one of said one or more reaction rollers is embodied in, or constituted by, the top centre roller.

33) A stairlift including a stairlift rail; and a carriage as claimed in any one of claims 28 to 32 displaceable along said rail.

34) A stairlift as claimed in claim 33 wherein said rail is as claimed in any one of claims 1 to 6.

35) A stairlift carriage having a single roller positioned to contact a first side of a stairlift rail, and three rollers positioned to contact spaced points along a side of said rail substantially opposite to said first side, the axes of said single roller and the centre of said three rollers being fixed in a plane through the contact points of those two rollers and said rail when in use, the outer two of said three rollers being constrained to swivel, in a mirror fashion to one another, in a plane perpendicular to said first mentioned plane, to allow said carriage to negotiate inside/outside bends in said rail.

36) A stairlift carriage as claimed in claim 35 wherein the axis about which each outer roller swivels lies between parallel lines passing through the axes of the respective outer roller, and said centre roller.

37) A stairlift carriage as claimed in claim 35 or claim 36 wherein biasing means are provided to bias the axes of said outer rollers toward the surface of said rail.

38) A stairlift carriage as claimed in claim 37 wherein said biasing means comprise compression springs.

39) A stairlift carriage as claimed in any one of claims 35 to 38 further including at least one reaction roller positioned to, in use, contact said rail, said at least one reaction roller being mounted so as to counter rotation of the carriage about said rail.

40) A stairlift carriage as claimed in claim 39 wherein one of said reaction rollers comprises the centre roller of said three rollers.

41) A stairlift carriage for mounting on a stairlift rail, said carriage having a carriage chassis; a centre roller assembly; a leading roller assembly positioned ahead of said centre roller assembly when viewed in the direction of travel of said carriage; and a trailing roller assembly positioned behind said centre roller assembly when viewed in the direction of travel of said carriage, said centre, leading and trailing roller assemblies being configured and arranged to support said carriage on said rail, and said leading and trailing roller assemblies being constrained to move substantially in a mirror image of one another as said carriage negotiates an inside or an outside bend in said rail; said carriage being characterised in that:
(i) said centre roller assembly is fixed with respect to said carriage chassis; and
(ii) said leading and trailing roller assemblies are mounted to move, together, with respect to said carriage chassis along spaced parallel axes as said carriage negotiates a transition bend in said rail.

42) A stairlift carriage as claimed in claim 41 wherein the axes along which said leading and trailing roller assemblies move as said carriage negotiates a transition bend in said rail also define pivot points about which said leading and trailing roller assemblies move as said carriage negotiates an inside/outside bend in said rail.

43) A stairlift carriage as claimed in claim 41 or claim 42 wherein said centre roller assembly is configured and arranged to prevent said carriage from rotating about said rail.

44) A stairlift carriage as claimed in any one of claims 41 to 43 wherein said carriage further includes biasing means to bias said leading and trailing roller assemblies into contact with said rail.

45) A stairlift carriage having a plurality of rollers configured and arranged to support said roller on a srairlift rail, said carriage being characterised in that at least one of said rollers is contoured to correspond substantially to the curvature of said rail and is mounted for movement along its axis as said carriage negotiates a bend in said rail.

46) A stairlift assembly including a stairlift rail, and a carriage as claimed in any one of claims 35 to 45 displaceable along said rail.

47) A stairlift carriage when constructed arranged and operable substantially as hereinbefore described with reference to, and as illustrated in, FIGS. 4 to 11, or 12 to 18, or 19 to 21 of the accompanying drawings.

48) A stairlift assembly including the carriage claimed in claim 47; and the rail claimed in any one of claims 1 to 6.
